(19) United States
(12) Patent Application Publication
(10) Pub. No.: US 2025/0182405 A1
(43) Pub. Date: Jun. 5, 2025

(54) REDUCING PERFORMANCE REQUIREMENTS FOR ARTICIFIAL INTELLIGENCE (AI) OBJECTS IN VIRTUAL ENVIRONMENTS

(71) Applicant: Tencent Technology (Shenzhen) Company Limited, Shenzhen (CN)

(72) Inventors: Yang Zhang, Shenzhen (CN); Sze Yeung Liu, Shenzhen (CN)

(21) Appl. No.: 19/043,710

(22) Filed: Feb. 3, 2025

Related U.S. Application Data
(63) Continuation of application No. PCT/CN2023/129231, filed on Nov. 2, 2023.

(30) Foreign Application Priority Data
Jan. 9, 2023 (CN) 202310026972.7

(51) Int. Cl. G06T 19/00; A63F 13/577; G06T 13/40

(52) U.S. Cl. CPC G06T 19/00; A63F 13/577; G06T 13/40

(57) ABSTRACT

A method and apparatus for controlling an artificial intelligence (AI) virtual object to reduce performance overhead of a computing device. The method comprises: obtaining a virtual object community for a plurality of AI virtual objects; generating a first influence range corresponding to the virtual object community and a plurality of second influence ranges corresponding to a player virtual object, the first influence range corresponding to an activity range of the virtual object community in a virtual environment, and the second influence range being an influence range generated with the player virtual object as a center; determining a second influence range that intersects with the first influence range and that has a range size meeting a condition as a target second influence range; controlling, an activity of an AI virtual object in the plurality of AI virtual objects based on a control policy corresponding to the target second influence range.

### CROSS-REFERENCE TO RELATED APPLICATIONS

This application is a continuation application of PCT Application PCT/CN2023/129231, filed Nov. 2, 2023, which claims priority to Chinese Patent Application No. 202310026972.7 filed on Jan. 9, 2023, each entitled “METHOD AND APPARATUS FOR CONTROLLING AI VIRTUAL OBJECT, DEVICE, MEDIUM, AND PROGRAM PRODUCT”, and each which is incorporated herein by reference in its entirety.

### FIELD

Aspects described herein relate to the field of computer technologies, and in particular, to a method and apparatus for controlling an artificial intelligence (AI) virtual object, a device, a medium, and a program product.

### BACKGROUND

There are a large quantity of artificial intelligence (AI) virtual objects in open-world games, and the AI virtual objects may be non-player characters (NPCs) with autonomous behavioral capabilities.

To reduce performance overheads of a computer device, a level of detail (LOD) intersection test is performed on an AI virtual object, and a behavior tree for controlling the AI virtual object or an operating frequency of the behavior tree is determined based on a test result. A simple behavior tree and a relatively low operating frequency of the behavior tree cause the AI virtual object to have a coarser representation effect, thus reducing the performance overheads. During the LOD intersection test, it is determined whether influence ranges (LOD0, LOD1, LOD2, and the like) generated with a player virtual object as a center intersect with an influence range of the AI virtual object, and an influence range with a highest level of intersection (a range of LOD0 is smaller than that of LOD1, and a level of LOD0 is higher than that of LOD1) is selected as a final test result.

How to further reduce performance overheads of a computer device based on the related art becomes a technical problem that needs to be resolved urgently.

### SUMMARY

Aspects described herein provides a method and apparatus for controlling an AI virtual object, a device, a medium, and a program product to reduce performance overheads of a computer.

According to one aspect described herein, a method for controlling an AI virtual object is provided, performed by a computer device and including:
obtaining a virtual object community including a plurality of AI virtual objects;
generating a first influence range corresponding to the virtual object community and a plurality of second influence ranges corresponding to a player virtual object, the first influence range being configured for representing an activity range of the virtual object community in a virtual environment, the second influence range being an influence range generated with the player virtual object as a center, and different second influence ranges having different sizes;
determining a second influence range that intersects with the first influence range and that has a range size meeting a condition among the plurality of second influence ranges as a target second influence range; and
controlling, for any one of the plurality of AI virtual objects, an activity of the AI virtual object based on a control policy corresponding to the target second influence range.

According to another aspect, an apparatus for controlling an AI virtual object is provided, including:
an obtaining module, configured to obtain a virtual object community including a plurality of AI virtual objects;
a generation module, configured to generate a first influence range corresponding to the virtual object community and a plurality of second influence ranges corresponding to a player virtual object, the first influence range being configured for representing an activity range of the virtual object community in a virtual environment, the second influence range being an influence range generated with the player virtual object as a center, and different second influence ranges having different sizes;
a determining module, configured to determine a second influence range that intersects with the first influence range and that has a range size meeting a condition among the plurality of second influence ranges as a target second influence range; and
a control module, configured to control, for any one of the plurality of AI virtual objects, an activity of the AI virtual object based on a control policy corresponding to the target second influence range.

According to one aspect, a computer device is provided, including: a processor and a memory, the memory storing a computer program, the computer program being loaded and executed by the processor to implement the method for controlling an AI virtual object as described above.

According to another aspect, a computer-readable storage medium is provided, the storage medium storing a computer program, the computer program being loaded and executed by a processor to implement the method for controlling an AI virtual object as described above.

According to another aspect, a computer program product is provided, the computer program product including computer instructions stored in a computer-readable storage medium, a processor of a computer device reading the computer instructions from the computer-readable storage medium, and the processor executing the computer instructions to enable the computer device to implement the method for controlling an AI virtual object according to the foregoing aspects.

The technical solutions provided in aspects described herein have at least the following beneficial effects:

Intersection tests are performed on a plurality of second influence ranges of a player virtual object with a first influence range corresponding to a virtual object community, and a second influence range that intersects with the first influence range and that has a range size meeting a condition among the plurality of second influence ranges is determined as a target second influence range. For any AI virtual object in the virtual object community, an activity of the AI virtual object is controlled based on a control policy corresponding to the target second influence range, so that performance overhead of a computer can be further reduced. Compared with the related art in which an intersection test is performed on each AI virtual object independently (to determine an influence range of a player virtual object within which the AI virtual object falls), aspects described herein have the intersection test performed with a virtual object community as a whole, thereby reducing the performance overheads of the computer.

In addition, if AI virtual objects having a nature of a community are controlled by using the related art, AI virtual objects within a same community may fall within different influence ranges. In this case, the AI virtual objects within the community behave inconsistently. If this runs for a long time, the nature of the community (for example, uniformity in an activity range in a virtual environment) may be destroyed. However, in the aspects described herein, a same control policy is used for AI virtual objects in a same community, so that behavioral uniformity of the AI virtual objects in the community is maintained.

### BRIEF DESCRIPTION OF THE DRAWINGS

FIG. 1 is a schematic diagram showing that an AI virtual object falls within an influence range in the related art.

FIG. 2 is a schematic diagram of an interface representation of an AI virtual object according to an illustrative aspect described herein.

FIG. 3 is a schematic diagram of a computer system according to an illustrative aspect described herein.

FIG. 4 is a flowchart of a method for controlling an AI virtual object according to an illustrative aspect described herein.

FIG. 5 is a schematic diagram of an intersection test according to an illustrative aspect described herein.

FIG. 6 is a flowchart of a method for generating a first influence range according to an illustrative aspect described herein.

FIG. 7 is a schematic diagram of a comparison between use of a fixed first influence range and use of a real-time first influence range according to an illustrative aspect described herein.

FIG. 8 is a schematic diagram of generating a first circular influence range according to an illustrative aspect described herein.

FIG. 9 is a flowchart of a method for generating a first influence range according to another illustrative aspect described herein.

FIG. 10 is a schematic diagram of a method for generating a first influence range according to another illustrative aspect described herein.

FIG. 11 is a schematic diagram showing three stages of determining a control policy for an AI virtual object according to an illustrative aspect described herein.

FIG. 12 is a flowchart of a method for controlling an AI virtual object according to another illustrative aspect described herein.

FIG. 13 is a schematic diagram showing an effect of a method for controlling an AI virtual object according to an illustrative aspect described herein.

FIG. 14 is a block diagram of a structure of an apparatus for controlling an AI virtual object according to an illustrative aspect described herein.

FIG. 15 is a block diagram of a structure of a computer device according to an illustrative aspect described herein.

### DETAILED DESCRIPTION

The following terms involved in aspects described herein are briefly introduced below.

Level of detail (LOD): represents a level of picture fineness or logical complexity in a game.

Artificial intelligence level of detail (AILOD): a LOD for an AI virtual object.

Hierarchical level of detail (HLOD): a representation of a LOD as a tree hierarchy.

AI-HLOD: a HLOD applied to the field of AI.

Virtual environment: a virtual environment displayed (or provided) when a client runs on a terminal (e.g., computing device). The virtual environment may be a simulated environment of a real world, a semi-simulated semi-fictional environment, or a purely fictional environment. The virtual environment may be any one of a two-dimensional virtual environment, a 2.5-dimensional virtual environment, and a three-dimensional virtual environment. This is not limited in the aspects described herein. For example, the following aspects may describe a three-dimensional virtual environment.

In one aspect, the virtual environment may provide a battle environment for virtual objects. For example, in an open world game, a player may freely control a virtual object to roam in a virtual environment, and may freely select a time point and a manner for completing a game task. While roaming, the player-controlled virtual object may interact with an AI virtual object in the virtual environment. In another example, in a battle royale game, at least one virtual object plays in a single-round battle in the virtual environment. The virtual object survives in the virtual environment by avoiding an attack launched by an enemy unit and dangers (such as a poison gas circle and a swamp) in the virtual environment. When a hit point value of the virtual object in the virtual environment is zero, life of the virtual object in the virtual environment ends. A virtual object that successfully passes a route within a level wins finally. For example, in an adventure game, at least one virtual object plays in a single-round battle in the virtual environment, and the virtual object acquires clearance permission for a current level by killing a monster, to enter a next level or to end the current battle.

Virtual object: a movable object in a virtual environment. The movable object may be a virtual person, a virtual animal, a cartoon person, or the like, for example, a person or an animal displayed in a three-dimensional virtual environment. In one aspect, the virtual object may be a three-dimensional model created based on a skeletal animation technology. Each virtual object may have a shape and a volume in the three-dimensional virtual environment, and may occupy a part of space in the three-dimensional virtual environment. An AI virtual object and a player virtual object may exist in the virtual environment. The AI virtual object may be an NPC with autonomous behavior capabilities. For example, assuming that the AI virtual object is a virtual animal, the AI virtual object may simulate a behavior of an animal in a real world as a virtual activity, such as hunting, running, and migration. In another example, assuming that the AI virtual object is a virtual person, the AI virtual object may simulate behaviors in the real world to perform anthropomorphic virtual activities, such as at least one behavior of chatting, working, and living. The player virtual object may be a virtual object controlled by a player.

Unreal Engine (UE) 4: UE4 is a development engine for an application program. The application program may include a game, and the like. The development engine is not limiting, and other engines may be used.

An AI virtual object may be controlled by using a finite state machine or a development framework component (for example, Behaviac) behavior tree of game AI. A finite-state machine may define a plurality of states of an AI virtual object and conditions for switching between the states. When the AI virtual object is in a state A, if a condition for switching the AI virtual object from the state A to a state B is satisfied, the AI virtual object may be switched from the state A to the state B. The AI virtual object performs different tasks in different states, determines to switch states through conditions, and combines a series of states and switching conditions into a complete AI virtual object representation. The finite-state machine has advantages of both simple principles and implementations, but has a clear disadvantage of generally being applicable to a case in which states are finite and a transition relationship is simple. In a large-world game, AI virtual objects may be complex in representation, the AI virtual objects are divided into may have a large quantity of states, and may have complex transition relationships between different states. In this case, a finite state machine might have too low of an abstraction level and might not be intuitive.

Behaviac behavior tree: a behavior tree implementation solution, which may implement switching between execution nodes of a behavior tree by using control nodes, such as selector, sequence, parallel, and/or condition. During running of the behavior tree, a representation of an AI virtual object may be switched by switching different execution nodes. An advantage of the Behaviac behavior tree is that only simple execution and condition nodes may be used on a service side to decouple service logic and behavior tree control logic, which may be applied to a relatively complex AI virtual object representation. However, the Behaviac behavior tree might not support a blackboard function, might not be intuitive for debugging, and might not be preferred for parallel nodes.

An AI virtual object and a player virtual object may exist in a virtual environment. The AI virtual object may be an NPC with autonomous behavior capability, and the player virtual object may be a virtual object controlled by a player. In the related art, an influence range of a player virtual object within which each AI virtual object of a plurality of AI virtual objects falls may be determined. A control policy for each AI virtual object may be determined based on a corresponding influence range.

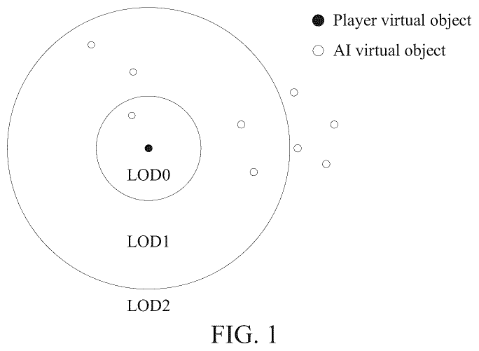

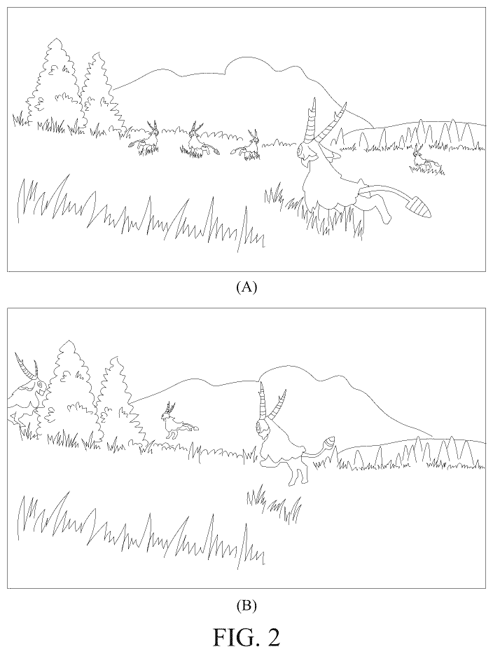

FIG. 1 is a schematic diagram of an influence range within which an AI virtual object falls in. In FIG. 1, a plurality of influence ranges (which may be represented as circles) may be generated based on a distance from a player virtual object (which may be a center of the plurality of influence ranges). Different levels may correspond to the plurality of influence ranges, such as LOD0, LOD1, LOD2, etc. A higher level may indicate a smaller influence range. For example, a level of LOD0 may be higher than a level of LOD1, and an influence range corresponding to LOD0 may be smaller than an influence range corresponding to LOD1. For example, FIG. 1 shows nine AI virtual objects. Whether the nine AI virtual objects intersect with the plurality of influence ranges may be determined one by one. An AI virtual object may fall within an influence range corresponding to LOD0, LOD1, or LOD2. An activity of the AI virtual object may be controlled based on a determining result by using a control policy corresponding to the determining result. If the AI virtual object falls within the influence range of LOD0, more complex and stricter logic processing may be performed than if the AI virtual object falls within the influence range corresponding to LOD1. In other words, a lower LOD level (a larger LOD value) indicates simpler processing logic of the AI virtual object, a coarser interface representation, and lower performance overhead consumption. As shown in FIG. 2, part (A) of FIG. 2 shows a representation of an AI virtual object falling within an influence range of LOD2. In this case, the AI virtual object moves in a direct translation manner. In this case, limbs of the AI virtual object may be disengaged from the ground. A reason may be that a control policy corresponding to LOD2 does not use a strict pathfinding and movement algorithm to control the AI virtual object to move, but only interpolation translation may be performed between a start point and an end point. Part (B) of FIG. 2 shows a representation of an AI virtual object falling within an influence range of LOD0. In this case, the representation of the AI virtual object may be normal movement.

However, there are a large quantity of AI virtual objects in an open-world game, and determining an intersection between each AI virtual object and an influence range of a player virtual object may generate high performance overheads. To resolve this problem, aspects described herein provide the following method for controlling an AI virtual object.

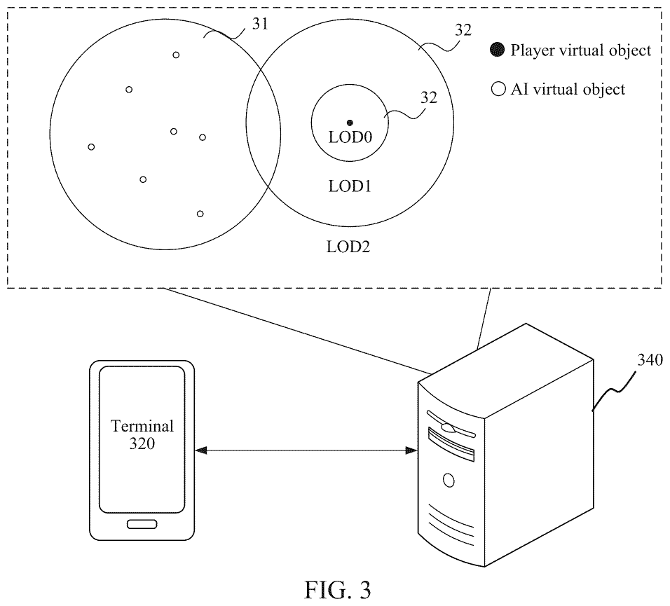

FIG. 3 is a schematic diagram of a computer system according to an illustrative aspects described herein. The computer system includes a terminal 320 and a server 340. An application program supporting a virtual environment may be installed and run on the terminal 320. The application program may be any one of a massively multiplayer online game (MMOG), a role-playing game (RPG), a three-dimensional map program, a virtual reality (VR) application program, and an augmented reality (AR) program. The terminal 320 may be a terminal used by a user. The user uses the terminal 320 to control a virtual character located in the virtual environment to perform an activity. The activity includes but is not limited to at least one of adjusting a body posture, walking, running, jumping, riding, driving, aiming, picking up, using a throwing item, or attacking another virtual character. For example, the virtual character may be a virtual person, such as a simulated person object or a cartoon person object. In one aspect, the terminal 320 may be further connected to an external connection device, for example, a mouse, a keyboard, a gamepad, a speaker, VR/AR glasses, or a VR/AR helmet. The user performs data exchange with the terminal 320 through the external connection device, to control the virtual character to perform the activity in the virtual environment. The terminal 320 may be connected to the server 340 through a wireless network or a wired network. The server 340 includes at least one of a server, a plurality of servers, a cloud computing platform, and a virtualization center (only one server is shown in FIG. 3). For example, the server 340 includes a processor and a memory, and the memory includes a receiving module, a control module, and a sending module. The receiving module may be configured to receive a request sent by a client, for example, a teaming request. The control module may be configured to control picture rendering of the virtual environment. The sending module may be configured to send a response to the client, for example, send prompt information of teaming success to the client. The server 340 may be configured to provide a backend service for an application program supporting a three-dimensional virtual environment. In one aspect, the server 340 may be responsible for primary computing work, and the terminal 320 may be responsible for secondary computing work. Alternatively, the server 340 may be responsible for secondary computing work, and the terminal 320 may be responsible for primary computing work. Alternatively, a distributed computing architecture may be used between the server 340 and the terminal 320 for collaborative computing.

In one aspect, the application program installed on the terminal 320 may be application programs on different operating system platforms (Windows, Mac, Linux, and the like). The terminal 320 may generally be one of a plurality of terminals. The terminal 320 is only used as an example for description in this aspect. A device type of the terminal 320 includes at least one of a desktop computer, a laptop computer, a smartphone, a smart TV, a wearable device, a tablet computer, an in-vehicle terminal, an e-book reader, an MP3 player, and an MP4 player.

A person skilled in the art may learn that there may be more or fewer terminals. For example, there may be only one terminal, or there may be dozens or hundreds of terminals, or more terminals. The quantity and device types of terminals are not limited in the aspects described herein.

The terminal 320 or the server 340 may perform intersection tests between a virtual object community shown in FIG. 3 and a plurality of influence ranges corresponding to a player virtual object (the intersection tests shown in FIG. 3 are performed by the server 340). In an aspect, a plurality of AI virtual objects in the virtual environment form a virtual object community, and the plurality of AI virtual objects perform an action in a form of the community. In FIG. 3, a first influence range 31 of the virtual object community may be generated, and the first influence range 31 may be configured for representing an activity range of the plurality of AI virtual objects. FIG. 3 further shows that a plurality of second influence ranges 32 are generated based on different preset radius lengths with the player virtual object as a center. Different second influence ranges 32 correspond to different LOD levels (LOD0, LOD1, and LOD2). It can be seen from FIG. 3 that the first influence range 31 intersects with both a second influence range 32, corresponding to LOD1, and a second influence range 32, corresponding to LOD2, and the second influence range 32, corresponding to LOD1, with a highest level in the intersecting second influence ranges 32 may be determined as a test result of the intersection test. After the test result of the intersection test may be determined, for any AI virtual object in the virtual object community, an activity of the AI virtual object may be controlled based on a control policy corresponding to the test result.

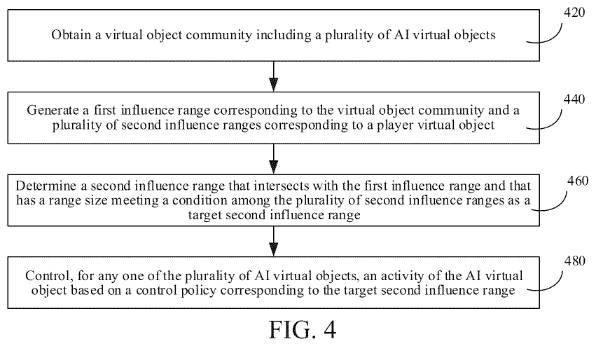

FIG. 4 is a flowchart of a method for controlling an AI virtual object according to an illustrative aspect described herein. Description is provided by using an example in which the method is performed by the computer system (including the terminal 320 and/or the server 340) shown in FIG. 3. The method includes the following operations.

Operation 420: Obtain a virtual object community including a plurality of AI virtual objects.

The AI virtual object refers to an NPC having an autonomous behavior capability. In some aspects, the AI virtual object may be a movable object, controlled by a state machine or a behavior tree, in a virtual environment. In one aspect, the AI virtual object may be referred to as an Agent.

The virtual object community may be a community formed by a plurality of AI virtual objects, and the plurality of AI virtual objects may have a property of performing a uniform action in a unit of the community. For example, performing the uniform action in the unit of the community is configured for indicating that attribute information of performing virtual activities by AI virtual objects in the community is the same or similar, such as at least one of the following: Virtual activities of a plurality of AI virtual objects are controlled by a same state machine or behavior tree, or are controlled by state machines or behavior trees having a same parameter; ranges of virtual activities performed by the plurality of AI virtual objects in the virtual environment are the same; and types of virtual activities that can be performed by the plurality of AI virtual objects in the virtual environment are the same. It can be seen that performing the uniform action in the unit of the community does not restrict a plurality of AI virtual objects in the community from performing a same virtual activity at a same moment. In one aspect, the virtual object community includes at least two AI virtual objects. Additionally or alternatively, AI virtual objects in a virtual object community are same creatures with a preference for living in groups, and the virtual object community is obtained by dividing the AI virtual objects according to types of the AI virtual objects. For example, for migration behavior of a flock in the virtual environment, after moving to a new stationing point, the flock continues to perform some individual activities as a community, such as roaming, patrolling, and defending against external enemies, within an activity range of the stationing point. In another example, for a hunting behavior of wolves in the virtual environment, the wolves act together at night, fighting with the prey. After the fight, the wolves may continue to perform some individual activities as a pack, such as patrolling, collecting trophies, and feeding.

Additionally or alternatively, the virtual object community may be obtained through division based on distances between AI virtual objects. A plurality of AI virtual objects having relatively short distances are grouped into a same virtual object community, and the plurality of AI virtual objects in the community are always clustered within a specific range. There may be one or more virtual object communities in the virtual environment. In a case with a plurality of virtual object communities in the virtual environment, the plurality of virtual object communities may be sequentially traversed to obtain the plurality of virtual object communities.

Operation 440: Generate a first influence range corresponding to the virtual object community and a plurality of second influence ranges corresponding to a player virtual object.

The first influence range is configured for representing an activity range of the virtual object community in a virtual environment. The plurality of AI virtual objects in the virtual object community exhibit aggregation of positions, and the first influence range is configured for covering the aggregated AI virtual objects. In one aspect, in a case that there are three or more AI virtual objects, the first influence range is a circle circumscribing positions of the plurality of AI virtual objects. Further, the first influence range is a minimum circle circumscribing the positions of the plurality of AI virtual objects. In a case with two AI virtual objects, the first influence range is a circular range with a distance between positions of the two AI virtual objects as its diameter.

The player virtual object refers to a movable object controlled by a player. Generally, a camera model exists in a three-dimensional game to observe a virtual environment. The camera model is usually disposed at a position such as a head, a right shoulder, or a back of the player virtual object, to facilitate the player to substitute into the player virtual object to implement an RPG. To reduce computer performance overheads, when an AI virtual object is far away from the player virtual object, the AI virtual object may be controlled by using a relatively simple control policy. In this case, in a picture captured by the camera model, the AI virtual object that is far away has a relatively coarse representation form, while an AI virtual object that is relatively close has a relatively refined representation form. A reason for using distance is used as a measure of performance accuracy is that during a game, a player does not pay attention to an AI virtual object at a relatively far distance from the player. In this case, even if a distant AI virtual object performs simple performance, for example, a virtual activity of the distant AI virtual object does not conform to a rule of performing an activity in the real world, game experience of the player is not affected, a sense of immersion in a virtual environment in a large-world game is not damaged, and performance consumption of the large-world game is reduced instead.

The second influence range may be an influence range generated with the player virtual object as a center, and different second influence ranges may have different sizes. In one aspect, a size of the second influence range is preset. To implement a control policy of determining an AI virtual object based on a distance, a plurality of different distance levels further need to be preset. For example, with the player virtual object as a center, a circle with a radius of 100 may be a first distance level (LOD0), a circle with a radius of 400 may be a second distance level (LOD1), and a circle with a radius of 500 may be a third distance level (LOD2). For example, a unit of a radius of the second influence range may be a pixel, or may be a unit of a distance in the virtual environment, such as meters or centimeters.

In an aspect, the first influence range and the second influence range are two-dimensional planar ranges. The first influence range is any one of a circle, a trapezoid, or a square, and the second influence range is a circle.

In another aspect, the first influence range and the second influence range are three-dimensional influence ranges, the first influence range is any one of a sphere, a frustum, or a cube, and the second influence range is a sphere. The frustum refers to a frustum used when the camera model captures a field of view, and a three-dimensional model in the frustum is rendered onto a device screen.

In an aspect, the first influence range is generated in real time. The first influence range is generated based on positions of the plurality of AI virtual objects in the virtual object community. In one aspect, the first influence range is a circle, and a radius and a center of the first influence range are generated in real time. In one aspect, a circle circumscribing the positions of the plurality of AI virtual objects is determined as the first influence range. In one aspect, the first influence range is a frustum, and a size and positioning points of the first influence range are generated in real time. In one aspect, centroids of the plurality of AI virtual objects are determined, and the centroids are used as centers of the frustum. The frustum is a minimum frustum meeting a condition of covering the plurality of AI virtual objects. A contour of the minimum frustum passes through an outermost AI virtual object of the plurality of AI virtual objects.

Operation 460: Determine a second influence range that intersects with the first influence range and that has a range size meeting a condition among the plurality of second influence ranges as a target second influence range.

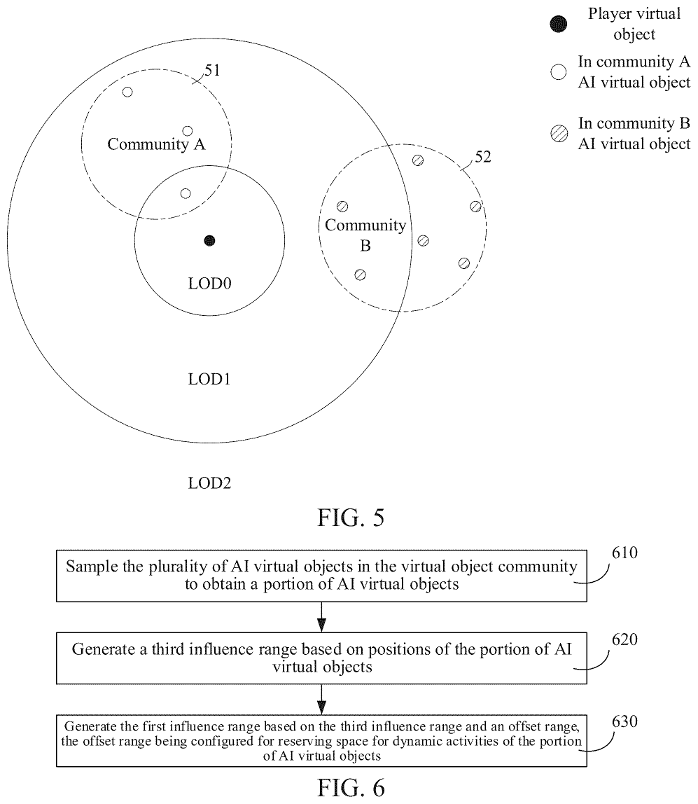

The target second influence range is a second influence range that intersects with the first influence range and that has a range size meeting a condition among the plurality of second influence ranges corresponding to the player virtual object. In an aspect, a second influence range that intersects with the first influence range and that has a smallest range among the plurality of second influence ranges corresponding to the player virtual object is determined as the target second influence range. Further, the range size meeting the condition is configured for indicating that the target second influence range is an influence range with a smallest area in at least two candidate second influence ranges, the candidate second influence range being a second influence range intersecting with the first influence range. For example, the target second influence range is an influence range with a smallest area in at least two candidate second influence ranges intersecting the first influence range. Additionally or alternatively, an area of the target second influence range is smaller than that of another influence range of the at least two candidate second influence ranges, and the another influence range is an influence range other than the target second influence range of the at least two candidate second influence ranges. With reference to FIG. 5, a first influence range 51 of a community A and a first influence range 52 of a community B are shown in FIG. 5. The first influence range 51 of the community A intersects with all the second influence ranges corresponding to LOD0, LOD1, and LOD2, and the second influence range corresponding to LOD0 with a smallest area is determined as the target second influence range. The first influence range 52 of the community B intersects with the second influence ranges corresponding to LOD1 and LOD2, and the second influence range corresponding to LOD1 with a smaller area is determined as the target second influence range.

Operation 480: Control, for any one of the plurality of AI virtual objects, an activity of the AI virtual object based on a control policy corresponding to the target second influence range.

In operation 460, the target second influence range has been determined, and each AI virtual object in the virtual object community may be controlled by using the control policy corresponding to the target second influence range.

In an aspect, a target behavior tree corresponding to the target second influence range is determined, and then, for any one of the plurality of AI virtual objects, an activity of the AI virtual object is controlled through the target behavior tree; and/or an operating frequency of a behavior tree corresponding to the target second influence range is determined, and then, for any one of the plurality of AI virtual objects, an activity of the AI virtual object is controlled based on the operating frequency of the behavior tree. The target behavior tree is a preset behavior tree that has a correspondence with the target second influence range among a plurality of behavior trees. In other words, a higher LOD level corresponding to the target second influence range indicates a more complex behavior tree that is used to control the activity of the AI virtual object; and/or a higher LOD level corresponding to the target second influence range indicates a higher operating frequency of the behavior tree that is used to control the activity of the AI virtual object. For example, the target second influence range corresponds to the target behavior tree. For example, the plurality of second influence ranges corresponding to the player virtual object have one-to-one corresponding behavior trees, and the plurality of second influence ranges are sorted in ascending order of ranges, to obtain a sequential queue. Correspondingly, the plurality of behavior trees may be sorted with reference to the sequential queue of the second influence ranges, to obtain a behavior tree queue. In the behavior tree queue, complexity of the behavior trees gradually increases, and/or the operating frequencies of the behavior trees gradually increase.

For example, for any one of the plurality of AI virtual objects, the activity of the AI virtual object is controlled through the control policy corresponding to the target second influence range, to ensure that a uniform virtual activity is performed in a unit of a community, and even if the AI virtual objects in the community are relatively far away, consistency of the virtual activity can be ensured. This avoids a case that the plurality of AI virtual objects in the community are split into a plurality of parts and the plurality of AI virtual objects in the community have different control policies. Characteristics are ensured that the AI virtual objects in the community have the same or similar attribute information for performing the virtual activity.

In summary, intersection tests are performed on a plurality of second influence ranges of a player virtual object with a first influence range corresponding to a virtual object community, and a second influence range that intersects with the first influence range and that has a range size meeting a condition among the plurality of second influence ranges is determined as a target second influence range. For any AI virtual object in the virtual object community, an activity of the AI virtual object is controlled based on a control policy corresponding to the target second influence range, so that performance overheads of a computer can be further reduced. Compared with the related art in which an intersection test is performed on each AI virtual object independently (to determine an influence range of a player virtual object within which the AI virtual object falls), the intersection test may be performed with a virtual object community as a whole, thereby reducing the performance overheads of the computer.

In addition, if AI virtual objects having a nature of a community are controlled by using the related art, AI virtual objects within a same community may fall within different influence ranges. In this case, the AI virtual objects within the community behave inconsistently. If this runs for a long time, the nature of the community (for example, uniformity in an activity range in a virtual environment) may be destroyed. However, in the aspects described herein, a same control policy is used for AI virtual objects in a same community, so that behavioral uniformity of the AI virtual objects in the community is maintained.

In one aspect, operation 460 in the foregoing may be implemented at least as any one of the following three optional implementations.

Implementation 1: Perform intersection tests on the plurality of second influence ranges sequentially with the first influence range in ascending order of the plurality of second influence ranges; and
determine, in a case that it is determined that an i^{th} second influence range of the plurality of second influence ranges intersects with the first influence range, the i^{th} second influence range as the target second influence range, and stop an intersection test corresponding to an (i+1)^{th} second influence range, i being a positive integer.

For example, in a case that the i^{th} second influence range intersects with the first influence range, the i^{th} second influence range is a first influence range that intersects with the first influence range in a sequence of the plurality of second influence ranges in ascending order. Due to the ascending order of the plurality of second influence ranges, the i^{th} second influence range is a smallest influence range among the influence ranges intersecting with the first influence range. In other words, a range size of the i^{th} second influence range meets the condition, and thus the i^{th} second influence range is determined as the target second influence range.

For example, stopping the intersection test corresponding to the (i+1)^{th} second influence range reduces computing resource occupancy for performing the intersection test on the virtual object community while ensuring that the target second influence range can be determined.

For example, with reference to FIG. 5 above, after the second influence range corresponding to LOD0 is obtained, an intersection test is performed on the second influence range corresponding to LOD0 with the first influence range. If the second influence range corresponding to LOD0 intersects with the first influence range, the second influence range corresponding to LOD0 is directly determined as the target second influence range. If the second influence range corresponding to LOD0 does not intersect with the first influence range, the second influence range corresponding to LOD1 is obtained, an intersection test continues to be performed on the second influence range corresponding to LOD1, and if the second influence range corresponding to LOD1 intersects with the first influence range, the second influence range corresponding to LOD1 is determined as the target second influence range. If the second influence range corresponding to LOD1 does not intersect with the first influence range, the second influence range corresponding to LOD2 is obtained, and so on.

Implementation 2: Perform intersection tests on the plurality of second influence ranges sequentially with the first influence range in descending order of the plurality of second influence ranges; and
determine a (j−1)^{th} second influence range as the target second influence range in a case that it is determined that a j^{th} second influence range of the plurality of second influence ranges does not intersect with the first influence range, and stop an intersection test corresponding to a (j+1)^{th} second influence range, j being an integer greater than 1.

For example, in a case that the j^{th} second influence range does not intersect with the first influence range, the j^{th} second influence range is a first influence range that does not intersect with the first influence range in a sequence of the plurality of second influence ranges in descending order. The (j−1)^{th} second influence range is a smallest influence range among the influence ranges intersecting with the first influence range. In other words, a range size of the (j−1)^{th} second influence range meets the condition, and the (j−1)^{th} second influence range is determined as the target second influence range.

For example, stopping the intersection test corresponding to the (j+1)^{th} second influence range reduces computing resource occupancy for performing the intersection test on the virtual object community while ensuring that the target second influence range can be determined.

For example, with reference to FIG. 5 above, after the second influence range corresponding to LOD2 is obtained, an intersection test is performed on the second influence range corresponding to LOD2 with the first influence range. The second influence range corresponding to LOD2 is all ranges in the virtual environment beyond the second influence range corresponding to LOD1. The second influence range corresponding to LOD2 intersects with the first influence range. The second influence range corresponding to LOD1 is further obtained, and an intersection test continues to be performed on the second influence range corresponding to LOD1. If the second influence range corresponding to LOD1 does not intersect with the first influence range, the second influence range corresponding to LOD2 is determined as the target second influence range. If the second influence range corresponding to LOD1 intersects with the first influence range, the second influence range corresponding to LOD0 is further obtained, and an intersection test is performed on the second influence range corresponding to LOD0 with the first influence range. If the second influence range corresponding to LOD0 does not intersect with the first influence range, the second influence range corresponding to LOD1 is determined as the target second influence range. If the second influence range corresponding to LOD0 intersects with the first influence range, because LOD0 is a smallest second influence range in the plurality of second influence ranges, the second influence range corresponding to LOD0 is determined as the target second influence range.

Implementation 3: Perform intersection tests on the plurality of second influence ranges one by one with the first influence range to obtain the at least two candidate second influence ranges; and
sort the at least two candidate second influence ranges in ascending order to obtain an order sequence, and determine a first second influence range in the order sequence as the target second influence range.

For example, the candidate second influence range is a second influence range intersecting with the first influence range. The intersection tests with the first influence range are performed on the plurality of second influence ranges to obtain a plurality of intersection test results in a one-to-one correspondence with the plurality of second influence ranges. The at least two candidate second influence ranges are influence ranges whose intersection test results are that the second influence ranges intersect with the first influence range. For example, the first second influence range in the order sequence is a smallest influence range in the at least two candidate second influence ranges. In other words, a range size of the first second influence range in the order sequence meets the condition, and thus the first second influence range in the order sequence is determined as the target second influence range.

In summary, an intersection test is performed by using a virtual object community as a whole, so that computer performance overheads are reduced. Sorting in descending order or in ascending order is performed, or the at least two candidate second influence ranges are sorted in ascending order, so that the target second influence range is determined in the plurality of second influence ranges, thereby ensuring that a same control policy is used for AI virtual objects in a same community, and that the AI virtual objects in the community maintain behavioral uniformity.

Based on the optional aspect shown in FIG. 4, operation 440 may be replaced with operation 610 to operation 630 shown in FIG. 6. FIG. 6 is a flowchart of a method for generating a first influence range according to an illustrative aspect described herein. The method includes the following operations:

Operation 610: Sample the plurality of AI virtual objects in the virtual object community to obtain a portion of AI virtual objects.

An AI virtual object and a player virtual object exist in a virtual environment, the AI virtual object being an NPC having an autonomous behavior capability, and the player virtual object being a virtual object controlled by a player.

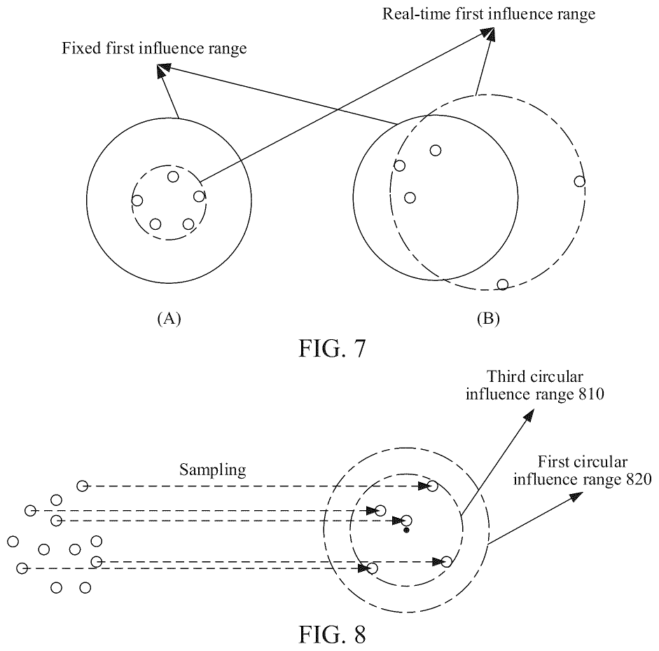

It can be learned from the foregoing description of operation 440 that the first influence range is to be generated in real time. Because the AI virtual object is a movable virtual object, if a fixed first influence range is used, there are two problems as shown in FIG. 7. Part (A) of FIG. 7 shows a case in which a real-time first influence range of a plurality of AI virtual objects is smaller than the fixed first influence range. Apparently, in the case shown in part (A), if use of the fixed first influence range significantly increases an activity range of the virtual object community, there is a clear error during an intersection test, and the fixed first influence range is too large to accurately reflect whether the player focuses on the AI virtual object. Part (B) of FIG. 7 shows another case in which a real-time first influence range of a plurality of AI virtual objects is larger than the fixed first influence range. Apparently, if the fixed first influence range is used, the plurality of AI virtual objects cannot be covered, and then a clear error is also caused during an intersection test. Movement of the AI virtual objects is ignored, and the fixed first influence range cannot accurately indicate position information of the AI virtual objects after the movement.

Therefore, the first influence range generated in real time instead of the fixed first influence range needs to be used. However, if the real-time first influence range is generated based on the plurality of AI virtual objects in the virtual object community, relatively large performance overheads are to be consumed for the generation of the first influence range due to a relatively large quantity of the AI virtual objects. Therefore, in this aspect, the plurality of AI virtual objects may be sampled to obtain a portion of AI virtual objects, for generating a real-time first influence range.

Three possible sampling schemes are described below.

In a first possible sampling scheme, in a case that a quantity of the plurality of AI virtual objects is greater than a first value, sampling is performed based on a first sampling rate to obtain the portion of AI virtual objects. In a case that a quantity of the plurality of AI virtual objects is not greater than a first value, the plurality of AI virtual objects may be fully sampled, and the plurality of AI virtual objects may be determined as the portion of AI virtual objects.

In one aspect, the first value is 3, and at least three AI virtual objects are required to perform subsequent operations of generating the first influence range. A value of the first sampling rate is not 100%. In one aspect, the first sampling rate is 40%. For example, the virtual object community includes 12 AI virtual objects, and 5 AI virtual objects are obtained by random sampling at a sampling rate of 40% and in a manner of rounding up. Further, the first sampling rate is determined based on the quantity of the plurality of AI virtual objects, and a product of the first sampling rate and the quantity of the plurality of AI virtual objects is greater than the first value.

In a second possible sampling scheme, the plurality of AI virtual objects in the virtual object community are sampled based on a first sampling rate to obtain candidate virtual objects; and the candidate virtual objects are determined as the portion of AI virtual objects in a case that a quantity of the candidate virtual objects is greater than a second value; or the candidate virtual objects are discarded in a case that a quantity of the candidate virtual objects is not greater than a second value; and the plurality of AI virtual objects in the virtual object community are re-sampled to obtain the portion of AI virtual objects whose quantity is the second value.

In one aspect, the first sampling rate is 40%. In one aspect, the second value is 3. For example, the virtual object community includes five AI virtual objects, and first sampling is randomly performed at a sampling rate of 40% and in a manner of rounding up, to obtain two AI virtual objects. Second sampling is performed on the five AI virtual objects, and three AI virtual objects are randomly sampled from the five AI virtual objects as the portion of AI virtual objects.

In a third possible sampling scheme (obtained by combining the first possible sampling scheme and the second possible sampling scheme), in a case that a quantity of the plurality of AI virtual objects is greater than a first value, the plurality of AI virtual objects in the virtual object community are sampled based on a first sampling rate to obtain candidate virtual objects. The candidate virtual objects are determined as the portion of AI virtual objects in a case that a quantity of the candidate virtual objects is greater than a second value. The candidate virtual objects are discarded in a case that a quantity of the candidate virtual objects is not greater than a second value; and the plurality of AI virtual objects in the virtual object community are re-sampled to obtain the portion of AI virtual objects whose quantity is the second value. In a case that the quantity of the plurality of AI virtual objects is not greater than the first value, full sampling is performed, and the plurality of AI virtual objects are determined as the portion of AI virtual objects. In one aspect, the first value is 3, the second value is 3, and the first sampling rate is 40%. For example, the virtual object community includes five AI virtual objects, it is determined that the five AI virtual objects exceed three AI virtual objects, and first sampling is randomly performed at a sampling rate of 40% and in a manner of rounding up, to obtain two AI virtual objects. Then, second sampling is performed on the five AI virtual objects, and three AI virtual objects are randomly sampled from the five AI virtual objects as the portion AI virtual objects.

Operation 620: Generate a third influence range based on positions of the portion of AI virtual objects.

The third influence range is an intermediate influence range in the process of generating the first influence range. In an aspect, the third influence range includes a third circular influence range, the third influence range being a circle circumscribing positions of the portion of AI virtual objects, and the first influence range includes a first circular influence range. With reference to FIG. 8, a third circular influence range shown in FIG. 8 is a circle circumscribing positions of the portion of AI virtual objects after sampling.

Operation 630: Generate the first influence range based on the third influence range and an offset range, the offset range being configured for reserving space for dynamic activities of the portion of AI virtual objects.

In an aspect, a radius of the third circular influence range is obtained; an offset value is added to the radius of the third circular influence range to obtain a radius of the first circular influence range, the offset value being not less than a radius of an activity range of the AI virtual object; and the first circular influence range is generated based on the radius of the first circular influence range.

For example, FIG. 8 is a schematic diagram of generating a first circular influence range. With reference to FIG. 8, there is an offset range between a third circular influence range 810 and a first circular influence range 820. Because the AI virtual object is a movable object, the AI virtual object changes in position at different moments, and a specific offset range needs to be reserved to ensure that a periphery of a body of each of the portion of AI virtual objects falls within the first circular influence range 820.

In summary, the first influence range is generated in real time through a portion of AI virtual objects obtained through sampling. In this way, not only beneficial effects brought by real-time generation are achieved, but also performance overheads of a computer are reduced by performing sampling on a plurality of AI virtual objects. The first influence range generated in real time is closer to the position of the AI virtual object than a fixed first influence range, thereby improving accuracy during the intersection test.

In addition, the third influence range is appropriately expanded by adding the offset value to obtain the first influence range. This can ensure that when the portion of AI virtual objects perform dynamic activities, their bodies still fall within the first influence range, thereby improving stability of the first influence range, and further improving accuracy of a test result of a subsequent intersection test.

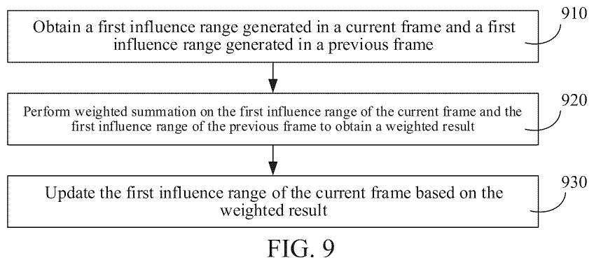

Based on the optional aspect shown in FIG. 4, operation 910 to operation 930 described below are further included after operation 440. FIG. 9 is a flowchart of a method for generating a first influence range according to an illustrative aspect described herein. The method includes the following operations:

Operation 910: Obtain a first influence range generated in a current frame and a first influence range generated in a previous frame.

Due to impact of a position change of the AI virtual object in the community, the generated first influence range fluctuates greatly, and in severe cases, the test result of the intersection test frequently changes. To resolve this problem, adaptable averaging processing is performed on the generated first influence range. In an aspect, the first influence range generated in the current frame and the first influence range generated in the previous frame are obtained. The previous frame may be a frame immediately before the current frame, or may be several frames before the current frame. This is not limited in this application. The several frames before the current frame may be a plurality of consecutive frames before the current frame, or may be a plurality of discrete frames before the current frame. A quantity of interval frames between a farthest frame (a frame farthest from the current frame in time) in the several frames and the current frame is not greater than a preset interval frame quantity threshold.

Operation 920: Perform weighted summation on the first influence range of the current frame and the first influence range of the previous frame to obtain a weighted result.

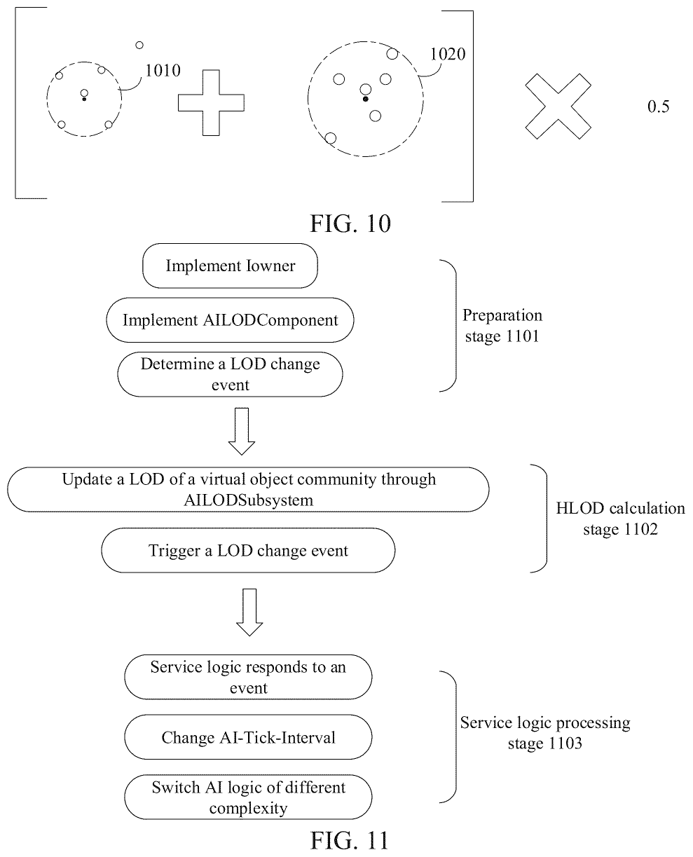

For example, the previous frame is a frame immediately before the current frame. FIG. 10 is a schematic diagram of performing weighted summation on a first influence range of a current frame and a first influence range of a previous frame. In this case, weighting coefficients for a first influence range 1010 of the current frame and a first influence range 1020 of the previous frame are both 0.5. During the weighted summation, the weighting coefficients for the first influence range of the current frame and the first influence range of the previous frame may be self-adjusted. If the weighting coefficient of the first influence range of the previous frame is relatively large, the weighted result is biased toward the previous frame, and the first influence range changes slowly. If the weighting coefficient of the first influence range of the current frame is relatively large, the result is biased toward the current frame, and the first influence range changes rapidly.

Operation 930: Update the first influence range of the current frame based on the weighted result.

The weighted result obtained through the weighted summation is updated to the first influence range of the current frame. For example, the weighted result indicates positions of center points of the first influence ranges and radius information of the first influence ranges. Specifically, the radius information of the first influence range of the current frame and the radius information of the first influence range of the previous frame that are carried in the weighted result are determined as the radius information of the first influence range based on a sum of the weighting coefficients. The center points of the first influence range of the current frame and the first influence range of the previous frame that are carried in the weighted result are offset according to the weighting coefficients, to determine a position of a center point of the first influence range. In an example in which the weighting coefficients are both 0.5, the center point of the first influence range is a midpoint of a line connecting the center point of the first influence range of the current frame and the center point of the first influence range of the previous frame.

In summary, due to impact of a position change of the AI virtual object in the community, a manner of generating the first influence range directly based on the position of the AI virtual object causes the first influence range to fluctuate greatly. In severe cases, a corresponding LOD level changes frequently accordingly, and the control policy changes continuously, causing the representation of the AI virtual object to be disordered. In the foregoing solution, the weighted summation is performed on the first influence ranges of the current frame and the previous frame, so that a change speed of the first influence range of the virtual object community can be customized, thereby affecting a frequency of changing the control policy, and improving stability of the representation of the AI virtual object.

FIG. 11 shows three stages of determining a control policy for an AI virtual object according to an illustrative aspect described herein. As shown in FIG. 11, a preparation stage 1101 includes implementing IOwer, implementing AILODcomponent, and determining a LOD change event. A HLOD calculation stage 1102 includes: updating a LOD level of a virtual object community through AILODSubsystem, and triggering a LOD change event. A service logic processing stage 1103 includes: service logic responding to an event, changing a behavior tree running interval (behavior tree running cycle), and switching behavior trees of different complexity. LOD: represents a level of picture fineness or logical complexity in a game. AILOD: represents a LOD level for an AI virtual object. HLOD represents a hierarchical level of LOD, and commonly divides a LOD into a tree hierarchy. AI-HLOD: a HLOD applied to the field of AI.

Preparation stage 1101: The virtual object community inherits an IOwner interface to implement logic at a host level. The IOwner interface is mainly configured to transfer host information to an AILOD-related component.

The virtual object community and the AI virtual object inherit an AILODComponent interface to implement an AILODComponent component. The AILODComponent component includes a policy for customized calculation of a LOD. A function interface related to HLOD (which refers to a hierarchical LOD level, such as LOD0, LOD1, and LOD2) in the AILODComponent component is configured to bind/unbind a parent-child relationship between the virtual object community and the AI virtual object. The corresponding AILODComponent component is mounted on the virtual object community and an instance of the AI virtual object.

A LOD change event is determined, so as to respond when the LOD level changes. When a program runs, all AILOD components are registered to an AILODSubsystem component, and the AILODSubsystem component is configured to manage the AILOD components.

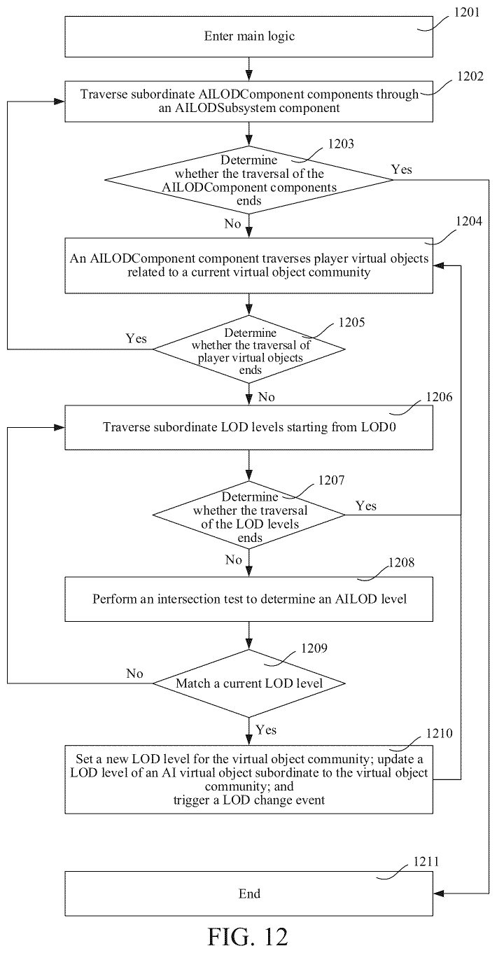

The HLOD calculation stage 1102 is shown in FIG. 12. FIG. 12 is a flowchart of a method for controlling an AI virtual object according to an illustrative aspect described herein. Description is provided by using an example in which the method is performed by the server 340 shown in FIG. 3. The method includes the following operations.

Operation 1201: Enter main logic.

During determining of a second influence range corresponding to an AI virtual object, the following operations are performed, starting from a Tick (clock cycle) of the main logic of the game program.

Operation 1202: Traverse subordinate AILODComponent components through an AILODSubsystem component.

The subordinate AILODComponent components are traversed through the AILODSubsystem component. The AILODComponent components are also constituent parts of virtual object communities and are in a one-to-one correspondence with the virtual object communities. Therefore, operation 1202 may be understood as traversing the virtual object communities.

Operation 1203: Determine whether the traversal of the AILODComponent components ends.

If all the AILODComponent components have been traversed, operation 1211 is performed; otherwise, operation 1204 is performed. Through the following operation 1204 to operation 1210, LOD levels are configured for the AILODComponent components one by one.

Operation 1204: An AILODComponent component traverses player virtual objects related to a current virtual object community.

A currently traversed AILODComponent component traverses the player virtual objects related to the current virtual object community.

Operation 1205: Determine whether the traversal of player virtual objects ends.

If all the player virtual objects have been traversed, operation 1202 is performed; otherwise, operation 1206 is performed. Through the following operation 1206 to operation 1210, a current AILODComponent component traverses each player virtual object in a virtual environment, and LOD levels are configured one by one.

Operation 1206: Traverse subordinate LOD levels starting from LOD0.

A plurality of LOD levels are set for one player virtual object, and the LOD levels are respectively LOD0, LOD1, LOD2, and so on. Starting from LOD0, LOD levels corresponding to a current player virtual object are traversed.

Operation 1207: Determine whether the traversal of the LOD levels ends.

If all the LOD levels have been traversed, operation 1204 is performed; otherwise, operation 1208 is performed. Through the following operation 1208 to operation 1210, the current AILODComponent component traverses each LOD level of a player virtual object in the virtual environment, and an intersection test is performed.

Operation 1208: Perform an intersection test to determine an AILOD level.

A manner of the intersection test is to perform overlapping determining on a first influence range corresponding to a virtual object community with a second influence range of a player virtual object. If there is an overlapping region, it is considered that the ranges intersect with each other. A LOD level corresponding to the intersecting second influence range is used as the AILOD level. For example, intersecting AILOD levels include LOD0, LOD1, and LOD2.

Operation 1209: Match a current LOD level.

It is determined whether the intersecting AILOD levels include a currently traversed LOD level, and if yes, operation 1210 is performed; otherwise, operation 1206 is performed to continue traversing a next LOD level.

Operation 1210: Set a new LOD level for the virtual object community; update a LOD

level of an AI virtual object subordinate to the virtual object community; and trigger a LOD change event.

If it is determined that a condition of LOD0 is met, it is considered that the virtual object community matches LOD0, and further determining is not performed on LOD1. Then, an AILOD level of the AI virtual object subordinate to the virtual object community is updated, and an AILOD change event is triggered.

Operation 1211 End.

By analogy, if all the AILODComponent components subordinate to the AILODSubsystem component have been traversed, it is equivalent to ending AILOD determining logic of the virtual object community.

Service logic processing stage 1103: In service logic of the game, because a LOD change event is determined, when the LOD changes, the event is received. The event transfers values before and after the LOD is updated, and corresponding processing is performed on the service logic side based on the two values. Before switching between a low LOD and a high LOD, some preparation work for switching may be performed, and then service logic of a specified LOD level is switched based on the changed LOD. A result of the switching may be changing a time interval of an Agent-AI Tick (for example, changing an operating frequency of a behavior tree for controlling the AI virtual object); or switching to AI logic of different complexity (for example, switching to behavior trees of different complexity), to change performance consumption.

The following describes beneficial effects of using the method for controlling an AI virtual object provided in the aspects described herein. A performance test is performed on a server using the method of the aspects described herein. A manner and an effect of the test are as follows:

Test environment: CPU: Intel (R) Core™ i7-7700 CPU @3.60 GHz; RAM: 32 GB; a UE4 dedicated server (DS)/client architecture is used; NPC-AI logic runs in a game thread of the DS; a player operation is simulated on a client, synchronized to the DS, and executed by the game thread of the DS (simulating a real player process); Scale: Scene: 10 km×10 km; AI virtual objects: 1000 to 5000, 100 NPC stationing points, and 80 birth points of AI virtual objects; Players: 100; Data collection: after running for 2 min, the distribution of the players and the AI virtual objects tends to be stable, and the collection is performed for 1 min, and ends.

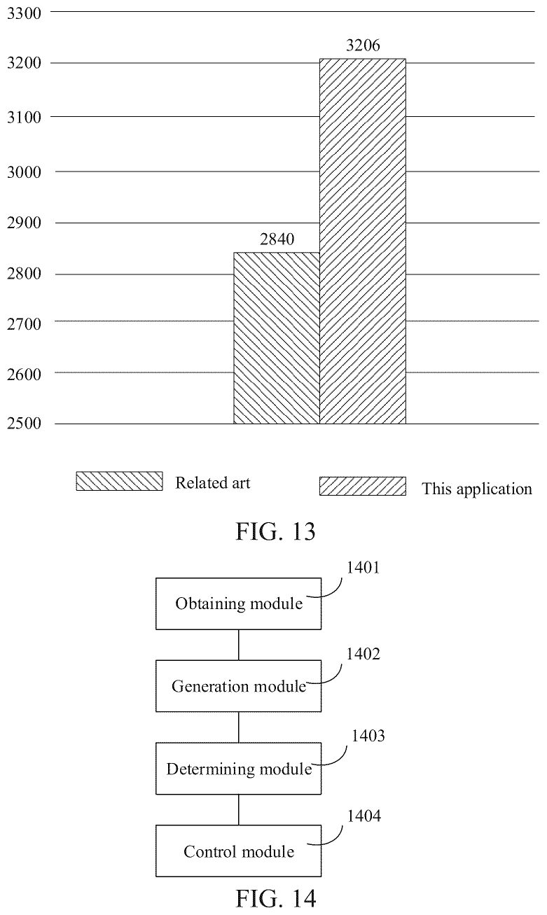

FIG. 13 shows a quantity of AI virtual objects that can be supported by the server and that is obtained through testing. In the related art, a server can support 2840 AI virtual objects, while according to the method for controlling an AI virtual object described herein, a server can support 3206 AI virtual objects.

FIG. 14 is a block diagram of a structure of an apparatus for controlling an AI virtual object according to an illustrative aspect described herein. The apparatus includes:
an obtaining module 1401, configured to obtain a virtual object community including a plurality of AI virtual objects;
a generation module 1402, configured to generate a first influence range corresponding to the virtual object community and a plurality of second influence ranges corresponding to a player virtual object, the first influence range being configured for representing an activity range of the virtual object community in a virtual environment, the second influence range being an influence range generated with the player virtual object as a center, and different second influence ranges having different sizes;
a determining module 1403, configured to determine a second influence range that intersects with the first influence range and that has a range size meeting a condition among the plurality of second influence ranges as a target second influence range; and
a control module 1404, configured to control, for any one of the plurality of AI virtual objects, an activity of the AI virtual object based on a control policy corresponding to the target second influence range.

In an optional aspect, the range size meeting the condition is configured for indicating that the target second influence range is an influence range with a smallest area in at least two candidate second influence ranges, the candidate second influence range being a second influence range intersecting with the first influence range.

In an optional aspect, the determining module 1403 is further configured to perform intersection tests on the plurality of second influence ranges sequentially with the first influence range in ascending order of the plurality of second influence ranges; and
determine, in a case that it is determined that an i^{th} second influence range of the plurality of second influence ranges intersects with the first influence range, the i^{th} second influence range as the target second influence range, and stop an intersection test corresponding to an (i+1)^{th} second influence range, i being a positive integer.

In an optional aspect, the determining module 1403 is further configured to perform intersection tests on the plurality of second influence ranges sequentially with the first influence range in descending order of the plurality of second influence ranges; and
determine, in a case that it is determined that a j^{th} second influence range of the plurality of second influence ranges does not intersect with the first influence range, a (j−1)^{th} second influence range as the target second influence range, and stop an intersection test corresponding to a (j+1)^{th} second influence range, j being an integer greater than 1.

In an optional aspect, the determining module 1403 is further configured to
perform intersection tests on the plurality of second influence ranges one by one with the first influence range to obtain the at least two candidate second influence ranges; and
sort the at least two candidate second influence ranges in ascending order to obtain an order sequence, and determine a first second influence range in the order sequence as the target second influence range.

In an optional aspect, the first influence range and the second influence range are two-dimensional planar ranges, the first influence range is any one of a circle, a trapezoid, or a square, and the second influence range is a circle; or the first influence range and the second influence range are three-dimensional influence ranges, the first influence range is any one of a sphere, a frustum, or a cube, and the second influence range is a sphere.

In an optional aspect, the generation module 1402 is further configured to sample the plurality of AI virtual objects in the virtual object community to obtain a portion of AI virtual objects; generate a third influence range based on positions of the portion of AI virtual objects; and generate the first influence range based on the third influence range and an offset range, the offset range being configured for reserving space for dynamic activities of the portion of AI virtual objects.

In an optional aspect, the generation module 1402 is further configured to sample, in a case that a quantity of the plurality of AI virtual objects is greater than a first value, the plurality of AI virtual objects based on a first sampling rate to obtain the portion of AI virtual objects; or
fully sample the plurality of AI virtual objects in a case that a quantity of the plurality of AI virtual objects is not greater than a first value, and determine the plurality of AI virtual objects as the portion of AI virtual objects.

In an optional aspect, the generation module 1402 is further configured to sample the plurality of AI virtual objects in the virtual object community based on a first sampling rate to obtain candidate virtual objects; and determine the candidate virtual objects as the portion of AI virtual objects in a case that a quantity of the candidate virtual objects is greater than a second value; or discard the candidate virtual objects in a case that a quantity of the candidate virtual objects is not greater than a second value, and re-sample the plurality of AI virtual objects in the virtual object community to obtain the portion of AI virtual objects whose quantity is the second value.

In an optional aspect, the third influence range includes a third circular influence range, the third influence range being a circle circumscribing positions of the portion of AI virtual objects, and the first influence range includes a first circular influence range. The generation module 1402 is further configured to obtain a radius of the third circular influence range; add an offset value to the radius of the third circular influence range to obtain a radius of the first circular influence range, the offset value being not less than a radius of an activity range of the AI virtual object; and generate the first circular influence range based on the radius of the first circular influence range.

In an optional aspect, the generation module 1402 is further configured to: obtain a first influence range generated in a current frame and a first influence range generated in a previous frame; perform weighted summation on the first influence range of the current frame and the first influence range of the previous frame to obtain a weighted result; and update the first influence range of the current frame based on the weighted result.

In an optional aspect, the control module 1404 is further configured to: determine a target behavior tree corresponding to the target second influence range; and control the activity of the AI virtual object through the target behavior tree.

In an optional aspect, the control module 1404 is further configured to: determine an operating frequency of a behavior tree corresponding to the target second influence range; and control the activity of the AI virtual object based on the operating frequency of the behavior tree.

In summary, intersection tests are performed on a plurality of second influence ranges of a player virtual object with a first influence range corresponding to a virtual object community, and a second influence range that intersects with the first influence range and that has a range size meeting a condition among the plurality of second influence ranges is determined as a target second influence range. For any AI virtual object in the virtual object community, an activity of the AI virtual object is controlled based on a control policy corresponding to the target second influence range, so that performance overheads of a computer can be further reduced. Compared with the related art in which an intersection test is performed on each AI virtual object independently (to determine an influence range of a player virtual object within which the AI virtual object falls), the intersection test may be performed with a virtual object community as a whole, thereby reducing the performance overheads of the computer.

In addition, if AI virtual objects having a nature of a community are controlled by using the related art, AI virtual objects within a same community may fall within different influence ranges. In this case, the AI virtual objects within the community behave inconsistently. If this runs for a long time, the nature of the community (for example, uniformity in an activity range in a virtual environment) may be destroyed. However, in the aspects described herein, a same control policy is used for AI virtual objects in a same community, so that behavioral uniformity of the AI virtual objects in the community is maintained.

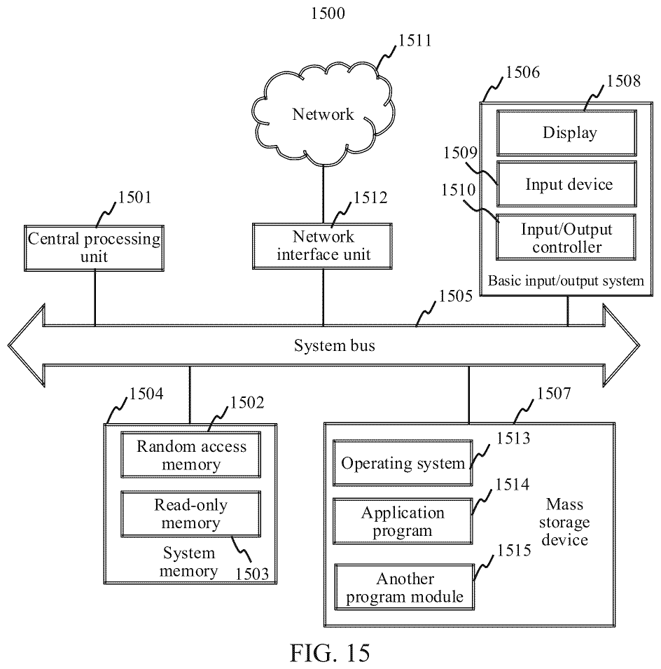

FIG. 15 is a schematic diagram of a structure of a computer device according to an illustrative aspect described herein. The computer device 1500 includes a central processing unit (CPU) 1501, a system memory 1504 including a random access memory (RAM) 1502 and a read-only memory (ROM) 1503, and a system bus 1505 connecting the system memory 1504 and the CPU 1501. The computer device 1500 further includes a basic input/output (I/O) system 1506 assisting in information transmission between components in the computer device, and a mass storage device 1507 configured to store an operating system 1513, an application program 1514, and another program module 1515.

The basic I/O system 1506 includes a display 1508 configured to display information and an input device 1509 such as a mouse or a keyboard that is configured for inputting information by a user. The display 1508 and the input device 1509 are both connected to the CPU 1501 through an I/O controller 1510 connected to the system bus 1505. The basic I/O system 1506 may further include the I/O controller 1510 to be configured to receive and process inputs from a plurality of other devices such as a keyboard, a mouse, and an electronic stylus. Similarly, the I/O controller 1510 further provides an output to a display screen, a printer, or another type of output device.

The mass storage device 1507 is connected to the CPU 1501 through a mass storage controller (not shown) connected to the system bus 1505. The mass storage device 1507 and a computer device readable medium associated therewith provide non-volatile storage for the computer device 1500. In other words, the mass storage device 1507 may include a computer device readable medium (not shown) such as a hard disk or a compact disc read-only memory (CD-ROM) drive.

Without loss of generality, the computer device readable medium may include a computer device storage medium and a communication medium. The computer device storage medium includes volatile and non-volatile media, and removable and non-removable media implemented by using any method or technology for storing information such as computer device readable instructions, data structures, program modules, or other data. The computer device storage medium includes a RAM, a ROM, an erasable programmable ROM (EPROM), an electrically EPROM (EEPROM), a CD-ROM, a digital versatile disc (DVD) or another optical memory, a tape cartridge, a magnetic cassette, a magnetic disk memory, or another magnetic storage device. Certainly, a person skilled in the art may learn that the computer device storage medium is not limited to the foregoing several types. The system memory 1504 and the mass storage device 1507 may be collectively referred to as a memory.

According to the aspects of the present disclosure, the computer device 1500 may be further connected, through a network such as the Internet, to a remote computer device on the network and run. That is, the computer device 1500 may be connected to a network 1511 through a network interface unit 1512 connected to the system bus 1505, or may be connected to another type of network or a remote computer device system (not shown) through a network interface unit 1512.

The memory further includes one or more programs. The one or more programs are stored in the memory. The CPU 1501 executes the one or more programs to implement all or some of the operations of the foregoing method for controlling an AI virtual object.

An aspect described herein further provides a computer device, including a processor and a memory, the memory storing at least one instruction, the at least one instruction being loaded and executed by the processor to implement the method for controlling an AI virtual object according to the foregoing method aspects.

An aspect described herein further provides a computer-readable storage medium, storing at least one instruction, at least one instruction being loaded and executed by a processor to implement the method for controlling an AI virtual object according to the foregoing method aspects.

An aspect described herein provides a computer program product or a computer program, including computer instructions, the computer instructions being stored in a computer-readable storage medium. A processor of a computer device reads the computer instructions from the computer-readable storage medium, and the processor executes the computer instructions, to enable the computer device to perform the method for controlling an AI virtual object according to the foregoing method aspects. The sequence numbers of the foregoing aspects described herein are merely for description purpose but do not imply the preference among the aspects.

A person of ordinary skill in the art may understand that all or some of the operations of the foregoing aspects described herein may be implemented by hardware, or may be implemented by a program instructing relevant hardware. The program may be stored in a computer-readable storage medium. The storage medium may be a ROM, a magnetic disk, an optical disc, or the like.

What is claimed is:

1. A method comprising:
generating a first influence range corresponding to a virtual object community and a plurality of second influence ranges corresponding to a player virtual object, wherein the virtual object community comprises a plurality of AI virtual objects, the first influence range corresponds to an activity range of the virtual object community in a virtual environment, the plurality of second influence ranges are generated with the player virtual object as a center, wherein different second influence ranges have different sizes;
determining a target second influence range, from the plurality of second influence ranges, that intersects with the first influence range and has a range size meeting a predefined condition; and
controlling one or more AI virtual objects in the plurality of AI virtual objects based on a control policy corresponding to the target second influence range.

2. The method according to claim 1, wherein the range size meeting the condition indicates that the target second influence range is an influence range with a smallest area in at least two candidate second influence ranges, and
wherein a candidate second influence range is a second influence range intersecting with the first influence range.

3. The method according to claim 2, wherein determining the target influence range further comprises:
performing intersection tests on the plurality of second influence ranges sequentially with the first influence range in ascending order of the plurality of second influence ranges; and
determining, based on an i^{th} second influence range of the plurality of second influence ranges intersecting with the first influence range, that the i^{th} second influence range is the target second influence range; and
stopping an intersection test corresponding to an (i+1)^{th} second influence range, wherein i is a positive integer.

4. The method according to claim 2, wherein the determining a target influence range further comprises:
performing intersection tests on the plurality of second influence ranges sequentially with the first influence range in descending order of the plurality of second influence ranges; and
determining, based on a j^{th} second influence range of the plurality of second influence ranges not intersecting with the first influence range, that a (j−1)^{th} second influence range is the target second influence range; and
stopping an intersection test corresponding to a (j+1)^{th} second influence range, wherein j is an integer greater than 1.

5. The method according to claim 2, wherein determining the target influence range further comprises:
performing intersection tests on the plurality of second influence ranges and the first influence range to obtain the at least two candidate second influence ranges; and
sorting the at least two candidate second influence ranges in ascending order to obtain an order sequence; and
determining a first second influence range in the order sequence as the target second influence range.

6. The method according to claim 1, wherein:
the first influence range and the second influence range are two-dimensional planar ranges, wherein:
the first influence range is any one of a circle, a trapezoid, or a square; and
the second influence range is a circle.

7. The method according to claim 1, wherein generating the first influence range corresponding to the virtual object community comprises:
sampling the plurality of AI virtual objects in the virtual object community to obtain one or more AI virtual objects;
generating a third influence range based on positions of the one or more AI virtual objects; and
generating the first influence range based on the third influence range and an offset range, wherein the offset range is configured to reserve space for dynamic activities of the one or more AI virtual objects.

8. The method according to claim 7, wherein sampling the plurality of AI virtual objects in the virtual object community to obtain one or more AI virtual objects comprises:
sampling, based on a quantity of the plurality of AI virtual objects exceeding a first value, the plurality of AI virtual objects based on a first sampling rate to obtain the one or more AI virtual objects.

9. The method according to claim 7, wherein sampling the plurality of AI virtual objects in the virtual object community to obtain one or more AI virtual objects comprises:
sampling the plurality of AI virtual objects in the virtual object community based on a first sampling rate to obtain candidate AI virtual objects; and
based on a quantity of candidate AI virtual objects exceeding a second value, determining the candidate AI virtual objects as the one or more AI virtual objects.

10. The method according to claim 7, wherein:
the third influence range is a circle circumscribing positions of the one or more AI virtual objects;
the first influence range is a circle; and
generating the first influence range based on the third influence range and an offset range further comprises:
obtaining a radius of the third influence range;
determining a radius of the first influence range by adding an offset value to the radius of the third influence range, wherein the offset value is not less than a radius of an activity range of an AI virtual object in the one or more AI virtual objects; and
generating the first influence range based on the radius of the first influence range.

11. The method according to claim 1, further comprising:
obtaining a first influence range generated in a current frame and a first influence range generated in a previous frame;
performing weighted summation on the first influence range of the current frame and the first influence range of the previous frame to obtain a weighted result; and
updating the first influence range of the current frame based on the weighted result.

12. The method according to claim 1, wherein controlling an activity of an AI virtual object in the plurality of AI virtual objects based on the control policy corresponding to the target second influence range comprises:
determining a target behavior tree corresponding to the target second influence range; and
controlling the activity of the AI virtual object based on the target behavior tree.

13. The method according to claim 6, wherein:
the first influence range and the second influence range are three-dimensional;
the first influence range is any one of a sphere, a frustum, or a cube; and
the second influence range is a sphere.

14. The method according to claim 1, wherein controlling an activity of an AI virtual object in the plurality of AI virtual objects based on the control policy corresponding to the target second influence range comprises:
determining a behavior tree corresponding to the target second influence range;
determining an operating frequency of the behavior tree; and
controlling the activity of the AI virtual object based on the operating frequency of the behavior tree.

15. One or more non-transitory computer readable media comprising computer readable instructions which, when executed, configure a data processing system to perform:
generating a first influence range corresponding to the virtual object community and a plurality of second influence ranges corresponding to a player virtual object, wherein:
the virtual object community comprises a plurality of AI virtual objects,
the first influence range corresponds to an activity range of the virtual object community in a virtual environment, and
the plurality of second influence ranges are generated with the player virtual object as a center, wherein different second influence ranges have different sizes;
determining a target second influence range, from the plurality of second influence ranges, that intersects with the first influence range and has a range size meeting a predefined condition; and
controlling one or more AI virtual objects in the plurality of AI virtual objects based on a control policy corresponding to the target second influence range.

16. The computer readable media according to claim 15, wherein generating the first influence range corresponding to the virtual object community comprises:
sampling the plurality of AI virtual objects in the virtual object community to obtain one or more AI virtual objects;
generating a third influence range based on positions of the one or more AI virtual objects; and
generating the first influence range based on the third influence range and an offset range, wherein the offset range is configured to reserve space for dynamic activities of the one or more AI virtual objects.

17. The computer readable media according to claim 16, wherein sampling the plurality of AI virtual objects in the virtual object community to obtain one or more AI virtual objects comprises:
sampling, based on a quantity of the plurality of AI virtual objects exceeding a first value, the plurality of AI virtual objects based on a first sampling rate to obtain the one or more AI virtual objects.

18. A system, comprising:
a processor; and
memory storing computer readable instructions which, when executed, configure the system to perform:
generating a first influence range corresponding to the virtual object community and a plurality of second influence ranges corresponding to a player virtual object, wherein:
the virtual object community comprises a plurality of AI virtual objects,
the first influence range corresponds to an activity range of the virtual object community in a virtual environment, and
the plurality of second influence ranges are generated with the player virtual object as a center, wherein different second influence ranges have different sizes;
determining a target second influence range, from the plurality of second influence ranges, that intersects with the first influence range and has a range size meeting a predefined condition; and
controlling one or more AI virtual objects in the plurality of AI virtual objects based on a control policy corresponding to the target second influence range.

19. The system according to claim 18, the range size meeting the condition indicates that the target second influence range is an influence range with a smallest area in at least two candidate second influence ranges, and
wherein a candidate second influence range is a second influence range intersecting with the first influence range.

20. The system according to claim 19, wherein determining the target influence range further comprises:
performing intersection tests on the plurality of second influence ranges sequentially with the first influence range in ascending order of the plurality of second influence ranges; and
determining, based on an i^{th} second influence range of the plurality of second influence ranges intersecting with the first influence range, that the i^{th} second influence range is the target second influence range; and
stopping an intersection test corresponding to an (i+1)^{th} second influence range, wherein i is a positive integer.
